(19) United States
(12) Patent Application Publication
(10) Pub. No.: US 2010/0245061 A1
(43) Pub. Date: Sep. 30, 2010

(54) APPARATUS AND METHOD FOR PROVIDING INFORMATION TO A VISUALLY AND/OR HEARING IMPAIRED OPERATOR

(75) Inventors: Brendan Michael Cassidy, Thornton Cleveleys (GB); Gilbert Cocokton, Whitely Bay (GB)

Correspondence Address: Zilka-Kotab, PC, P.O. BOX 721120, SAN JOSE, CA, 95172-1120, US

(73) Assignee: UNIVERSITY OF SUNDERLAND, Sunderland (GB)

(21) Appl. No.: 12/596,428

(22) PCT Filed: Apr. 17, 2008
(86) PCT No.: PCT/GB2008/001361

§ 371 Date: Jun. 9, 2010

(30) Foreign Application Priority Data
Apr. 18, 2007 (GB) 0707461.0

(51) Int. Cl. G08B 6/00

(52) U.S. Cl. 340/407.1

(57) ABSTRACT

A method and apparatus for providing information to an operator of a device, such as a currency dispensing machine, is disclosed. The apparatus includes a surface, for example a keypad, that is touched by an operator. The keys of the keypad vibrate in response to an input signal. By reference to a reference location, a centrally located key, the vibration indicates to the operator a direction. Variation in the intensity or duration of vibration pulses is also used to indicate distance or can be used to provide other information.

The present invention relates to a method and apparatus for providing information to an operator, and relates particularly, but not exclusively, to an apparatus and method for assisting a visually and/or hearing impaired user in using devices such as currency dispensing machines.

Many every day tasks involve a large amount of visual information being given to an operator making such tasks very difficult for people with visual impairments. For example, using a currency dispensing machine, also known as an ATM or cash machine, is very difficult for people with a visual impairment since a lot of information, in the form of instructions and requests, is provided on a small screen formed as part of the machine. In order to overcome this problem many cash machines are provided with a headphone socket allowing a visually impaired person to use an earphone to receive information and instructions from the machine. However, this has the disadvantage that it alerts anyone near to the cash machine that the person using the machine has a visual impairment. This makes the visually impaired operator very vulnerable to having cash stolen as it is dispensed from the machine.

There is therefore a need for a way of providing a visually impaired operator with information without drawing attention to the fact that the operator has a visual impairment. This is also the case when visually impaired operators use other devices and in other situations where information needs to be provided to a visually impaired person.

Preferred embodiments of the present invention seek to overcome the above disadvantages of the prior art.

According to an aspect of the present invention there is provided an apparatus for providing information to an operator of a device, the apparatus comprising: —

at least one surface adapted to be touched by an operator, portions of said surface being adapted to vibrate in response to an input signal, the surface having direction indicator means for indicating, by means of vibration, a direction relative to said surface portion; and
at least one vibrator device adapted to cause said portions to vibrate.

By providing directional information to an operator using vibration, the advantage is provided that a visually impaired operator can be provided with sufficient information that they can use the machine and because this information is provided by a vibrating haptic device, it is not apparent to people nearby that the operator has a visual impairment.

The direction indicator means may comprise at least one reference location whose location relative to said vibrating portion indicates a direction to said operator.

By providing direction indicator by using a reference location and a vibrating location the advantage is provided that a part of a device which is typically already being touched by an operator can be used as the direction indicator. For example, a typical 12 button keypad, which has 9 buttons numbered 1-9 and 3 further buttons, can be used to provide directional information using the number 5 as a reference location and the remaining numbers 1-9, which surround the 5, as 8 directional indicators. It is therefore possible for a visually impaired person using such a device to receive information without it being obvious that they have a visual impairment, since people without a visual impairment also touch the keypad.

In a preferred embodiment the vibrator devices are adapted to vary at least one of the intensity and duration of the vibration of the portion of the surface to provide additional information to said operator.

By varying the intensity and/or duration of the vibration it is possible to convey additional information to a person using the apparatus. For example, where a keypad is being used to indicate direction varying the intensity or duration of the vibrations can be used to indicate distance. The vibration is being used to indicate where a next action must take place. For example, if a cash machine is dispensing currency, the keypad can be used to indicate the direction in which the part of the apparatus where the cash is dispensed is located and how far away from the keypad it is. Thus if the cash is dispensed immediately below the keypad the button immediately below the number 5 is vibrated with a low intensity, whereas if the cash machine is below the keypad but is much further the same button is vibrated with a higher intensity.

In another preferred embodiment at least one vibrator device comprises at least one motor having a respective eccentric weight mounted on a rotating shaft of said motor.

At least one vibrator device may comprise a plurality of said motor at least two said motors having different eccentric weights mounted thereon.

By using two motors with two different eccentric weights the intensity of the vibration can be varied.

In a further preferred embodiment at least one surface portion comprises a button.

According to another aspect of the present invention, there is provided an apparatus for dispensing currency, the apparatus comprising: —

a device for holding, counting and passing to an operator amounts of currency; and
an apparatus according to any one of the preceding claims for providing information to said operator.

According to a further aspect of the present invention, there is provided a method of providing information to an operator of an apparatus, comprising causing at least one portion of a surface, that is adapted to be touched by an operator, to vibrate in response to an input signal, said surface having at least one direction indicator, the vibration indicating a direction to said operator.

The method may further comprise varying one of the intensity and duration of said vibration to provide additional information.

According to an aspect of the present invention there is provided a method of providing information via a vibrating haptic device about a device connected to said haptic device, comprising the steps: —

varying at least one of intensity and duration of a vibration signal output by a haptic device, thereby providing information about a device attached to said haptic device.

Existing haptic devices, that are used to alert a person to a change of status of a device to which they are attached, typically provide a single alert signal. For example, a mobile telephone or pager can have a vibrating device formed within them and this vibrating device is used to alert a person carrying the pager or phone. However, this is only used to alert the user of a change of status from not ringing to ringing or that a message has been received. The user can then look at the phone to determine what the change of status is, and for example, who is calling them. In the present invention, by varying the intensity and/or duration of vibration the advantage is provided that a person with a visual impairment can distinguish what type of change of status has occurred, for example the phone has started ringing and can be answered immediately or a text message has arrived which therefore may not need immediate attention. Furthermore, different types of vibration can be provided to indicate who is calling allowing the visually impaired person to decide whether to answer the call or not.

According to another aspect of the present invention, there is provided a computer program for controlling a haptic device adapted to vibrate to provide information, the program comprising: —

first computer code to vary at least one of intensity and duration of a vibration signal output by a haptic device providing information about a device attached to said haptic device.

According to a further aspect of the present invention there is provided a haptic device for providing information about a device attached to the haptic device, the haptic device comprising: —

at least one vibrating device adapted to varying at least one of intensity and duration of a vibration signal output by a haptic device, thereby providing information about a device attached to said haptic device.

Preferred embodiments of the present invention will now be described, by way of example only, and not in any limitative sense, with reference to the accompanying drawings in which: —

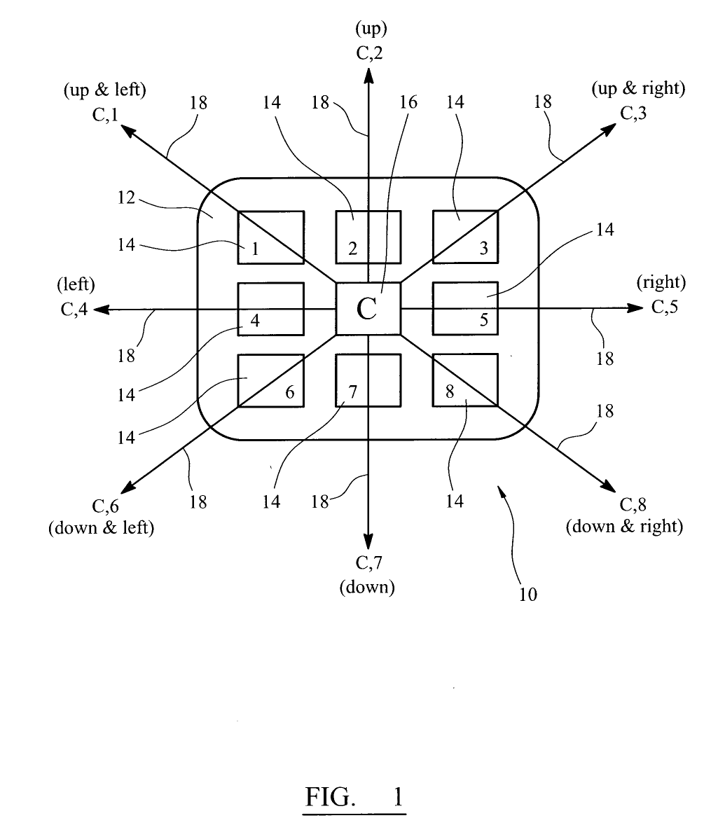

FIG. 1 is a schematic representation of an embodiment of the present invention;

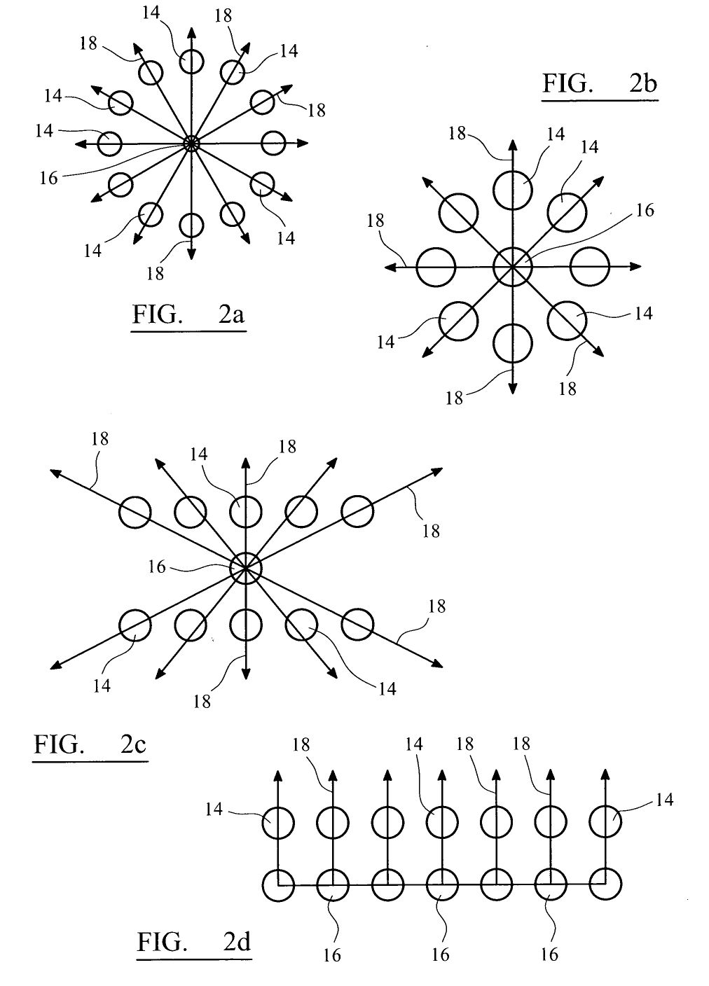

FIG. 2 is four further schematic representations of embodiments of the present invention;

FIG. 3 is a schematic representation of a currency dispensing apparatus of an embodiment of the present invention;

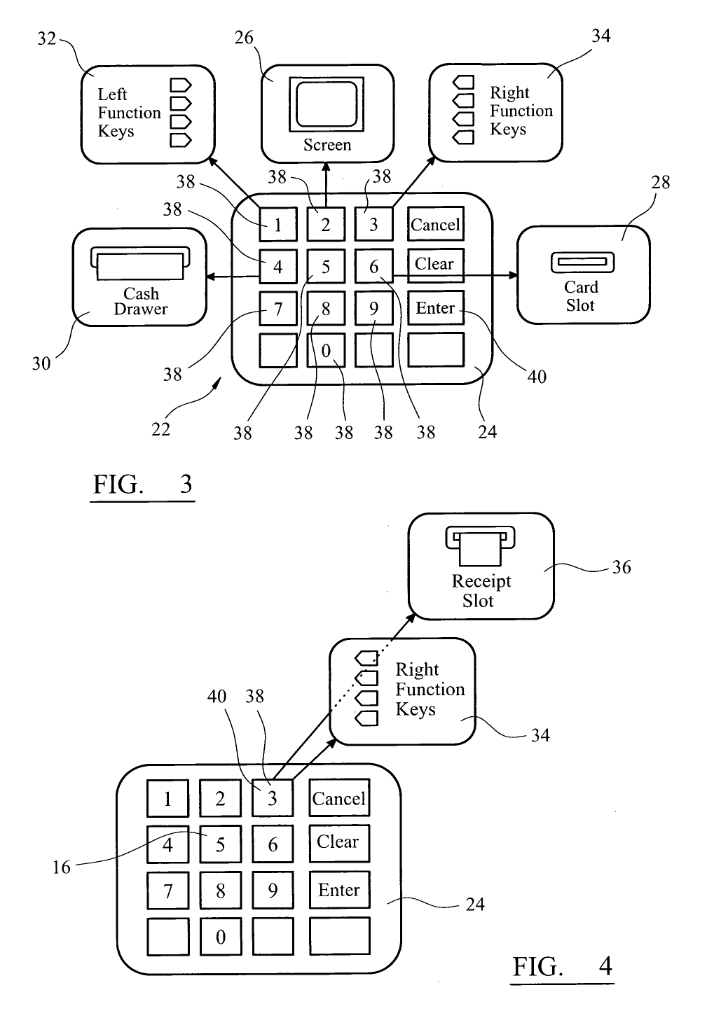

FIG. 4 is a further schematic representation of the apparatus of FIG. 3;

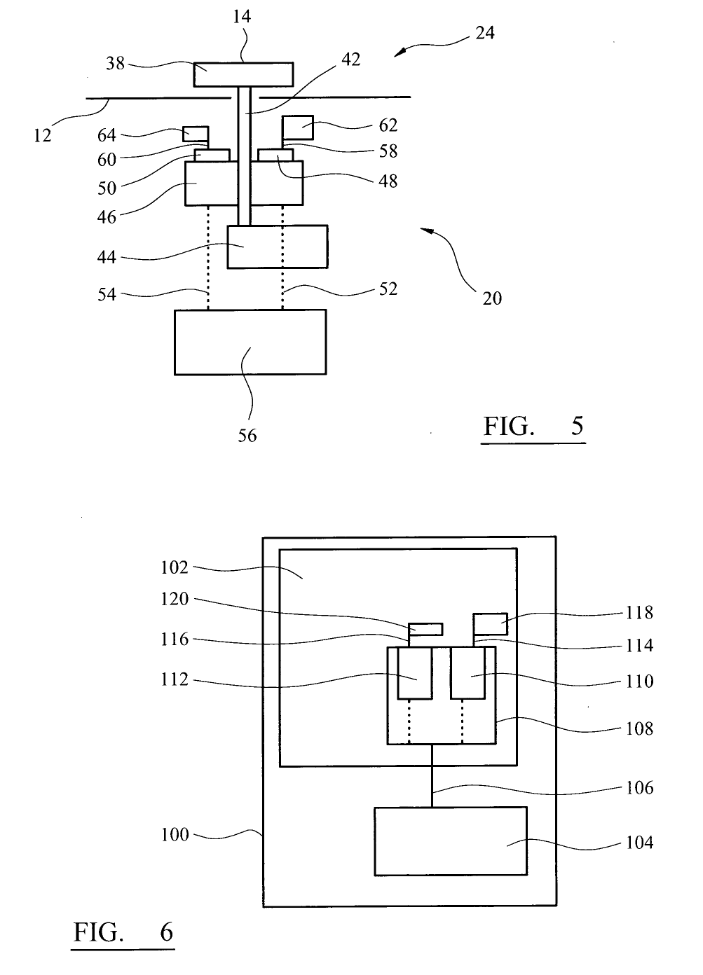

FIG. 5 is a side view of a key mechanism used in an embodiment of the present invention;

FIG. 6 is a schematic representation of an apparatus of another embodiment of the present invention;

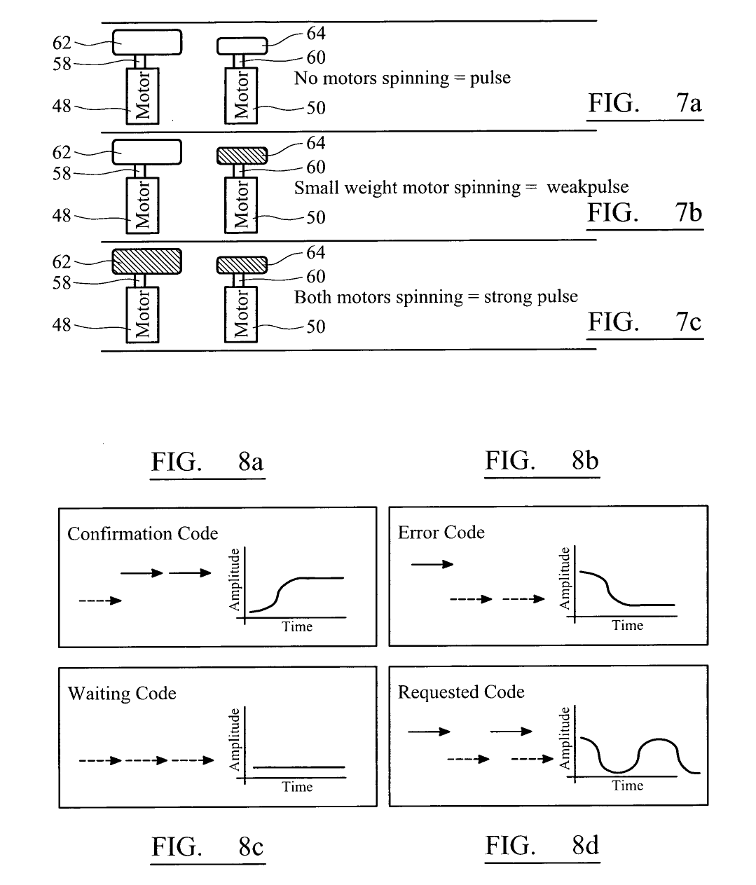

FIG. 7 is a table showing the use of vibrating devices used in embodiments of the present invention; and

FIG. 8 shows encoded information transmitted to an operator of the present invention.

Referring to FIG. 1, an apparatus 10 for providing information to an operator of a device, such as a currency dispensing machine, includes a surface 12 that is touched by the operator. Portions 14 of the surface 12 are adapted to vibrate in response to input signals, the surface 12 having direction indicating means 16 for indicating a direction relative to the vibrating surface portion. In the embodiment shown in FIG. 1 the direction indicating means is simply a central portion which is surrounded by the vibrating portions and therefore acts as a reference point. Direction is therefore indicated to the operator by using the reference portion 16 as a starting point the direction being a line extending from the reference point 16 through the vibrating portion 14 and extending therefrom. These directions are indicated by the lines labelled 18. Each of the vibrating portions 14 has a vibrating device 20, typically the type shown in FIG. 5, positioned underneath it causing the portion of surface 12 to vibrate in response to an input signal to the vibrating device 20.

The apparatus 10 shown in FIG. 1 is used in a numeric keypad, of the type used in currency dispensing devices. Alternative arrangements of the vibrating portions 14 and reference portion 16 are shown in FIG. 2. In FIGS. 2a, b and c the reference portion 16 is located on one or more lines of symmetry, with the reference portion 16 being located centrally relative to the vibrating portions 14. In FIG. 2d there is a series of reference portions 16 which each relate to an individual vibrating portion and is these paired reference and vibrating portions which give the directions 18. In this example each of the directions are parallel to each other.

Referring to FIG. 3, the apparatus is in the form of a currency dispensing apparatus or cash machine 22 having a keypad 24 the cash machine 22 also has a screen 26, a card slot 28 into which a credit or debit card is inserted, and a cash drawer 30 through which currency is dispensed. On either side of screen 26 are sets of function keys 32 and 34 and a receipt slot 36 (shown in FIG. 4) through which a receipt is dispensed. The keypad 24 has ten numeric keys 38 labelled 0-9 and three command keys 40 labelled “Cancel”, “Clear” and “Enter”.

Of the numeric keys 38 those labelled 1 2 3 4 and 6 are provided with vibrating devices 20 (not shown in FIGS. 3 and 4) which cause these keys 38 to vibrate. The vibration of the keys labelled 1 2 3 4 and 6 indicate a direction relative to a reference position, the key 38 labelled 5. As a result, the vibration of the key labelled 1 indicates a direction to the left and above the keypad 24 this being the position of the function keys 32. Vibration of the key labelled 2 indicates a direction directly above the keypad 24 this being where the screen 26 is positioned. Vibration of the key labelled 3 indicates a direction above and to the right of the keypad 24 this being the location of the function keys 34. Vibration of the key labelled 4 indicates a direction immediately to the left of keypad 24 this being the position of the cash drawer 30 and vibration of the key labelled 6 indicates a direction directly to the right of keypad 24 this being where the card slot 28 is located.

The keys 38 labelled 7 8 and 9, in this embodiment, are not provided with the vibrating devices 20 since they are not used to indicate direction. This is because, in this embodiment, there are no parts of the cash machine 22 in a direction below the keypad 24 which an operator needs to be directed towards. With different arrangements of cash machines these keys may need to be provided with vibrating devices in order to indicate these directions.

Referring to FIG. 4, in some cash machines 22 there may be more than one device of the cash machine located in the same direction. For example, as shown in FIG. 4, the function keys 34 and receipt slot 36 are both located above and to the right of the keypad 24. In this instance vibration of the key 38 labelled 3 indicates the direction above and to the left of keypad 24 and the intensity and/or duration of the vibration is varied in order to give an indication of distance from the keypad that the device is located. For example, a lower intensity vibration may be used to indicate a shorter distance and therefore indicating the function keys 34. A higher intensity, that is stronger, vibration indicates a longer distance from the keypad 24 thereby indicating the receipt slot 36. Alternatively, for a pulsed vibration the duration of the pulses can be varied with a short pulse length indicating a short distance and therefore the function keys 34 and a long pulse indicating a longer distance and the receipt slot 36. In a further alternative both intensity and duration could be varied in order to indicate these distances with a weaker short pulse indicating a short distance and a stronger long pulse indicating a greater distance.

Referring to FIG. 5, the vibrating device 20 which forms part of keypad 24 is connected to button 38. This button has an upper surface 14 which acts as part of the surface 12 that is touched by an operator. The surfaces 12 and 14 when viewed from above appear to form a single surface. However, the cross-sectional view of FIG. 5 shows they are separate surfaces although both touched by the operator and therefore acting as a single surface. The key 38 is connected via a shaft 42 to a micro switch 44 that detects the depression of key 38. Attached to shaft 42 is a motor casing 46 containing two motors 48 and 50. The motors 48 and 50 are connected, via respective connections 52 and 54, to a phidgets interface board 56 that is in turn connected to a controlling processor (not shown). The motors 48 and 50 have respective output shafts 58 and 60 to which are eccentrically mounted weights 62 and 64.

When a signal is sent from the processor to interface 56 and on via either connection 52 or 54 to motor 48 or 50 the rotation of the motor causes output shaft 58 or 60 to rotate and in turn the eccentrically mounted weights 62 and 64. The eccentric mounting of the weights causes them to vibrate casing 46 which in turn vibrates shaft 42 and key 38. The intensity of the vibration is determined by which of the weights 62 and 64 are caused to vibrate with the heavier weight 62 causing a more intense vibration of key 38 than the smaller weight 64. In the embodiment shown in FIG. 3 each of the keys 38 labelled 1, 2, 3, 4 and 6 is provided with a vibrating device 20 of the type shown in FIG. 5 and it could typically be the case that the keys 38 labelled 7 8 and 9 are also provided with such vibrating devices 20.

FIG. 7 shows how the motors 48 and 50 can be used to vary the intensity of the vibration in key 38. In FIG. 7a neither motor 48 nor 50 are spinning and therefore there is no vibration in key 38. In 7b, only motor 50 is spinning therefore the smaller weight 64 is also rotating providing a weak vibration in key 38. Finally, in 7c, both motors 48 and 50 are spinning causing the rotation of both weights 62 and 64 causing a stronger vibration of key 38. It is important to ensure that the rotation of the weights are phased correctly so that the vibration caused by the smaller weight 64 does not reduce the magnitude of the vibration caused by the larger weight 62. Alternatively the stronger vibration can be created by only causing the larger weight 62 to spin.

As demonstrated in FIG. 4, the intensity of the vibration can be varied in order to indicate to the operator the distance in a direction thereby effectively providing vector information. Varying the intensity of the vibrations can also be used to provide the operator with additional information. Examples of this information are shown in FIG. 8. For example, a confirmation code, shown in FIG. 8a, can consist of a weak pulse followed by two strong pulses, the graph showing the vibration amplitude against time. FIGS. 8b, c and d show alternative combinations of vibration providing alternative codes including error code, waiting code and requested code. This information is not necessarily provided in conjunction with directional information. For example, the whole could be caused to vibrate with a specific code indicating that machine is out of order. Thus a visually impaired person can tell simply by touching the keypad that the machine is out of order without having to insert their card.

Use of this technique of varying the intensity, or equally varying duration of vibration pulses, is not limited to devices of the type described above and this technique can be used in many other haptic devices. Vibrating haptic devices are commonly used to alert an operator of a change of status of a device connected to the haptic device. For example, it is common place for mobile telephones and pagers to be provided with a vibrating device to alert an operator to a change of status when the usual audio alert is likely to be ineffective. This can either be due to excessive background noise making it difficult for an operator to hear the audio alert. For a person without visual impairment the vibrating alert allows them to be aware of a change of status, for example the arrival of a text message or voice mail message or the mobile phone ringing. They can then look at the phone to determine the next action they should take. However, for a person with a visual impairment the vibration only indicates a change of status and gives no indication as to what that change of status is and therefore what action should be taken. For example, the action resulting from receiving a voice mail message is different from that of the phone ringing. This can be further extended to providing different patterns of vibration for different recognised callers thereby providing a person with a visual impairment with some of the additional information which is provided on the screen of a mobile phone, such as the number or name of the person calling.

Referring to FIG. 6, an apparatus, which could for example be a mobile phone 100 includes a vibrating haptic device 102 and a controlling processor 104 that is connected to the haptic device 102 via connection 106. The haptic device 102 includes a motor casing 108 that contains two motors 110 and 112. The output shafts 114 and 116 of motors 110 and 112 have eccentrically mounted weights that, when the shafts 114 and 116 are caused to rotate by motors 110 and 112 cause vibration of the haptic device 102 which in turn vibrates the mobile phone 100. The processor 104 is used to vary the duration of pulses or intensity of the vibration of the haptic device 102 by selecting which of the motors, and therefore which of the weights is rotated. The larger weight 118 causes a more intense vibration than the smaller weight 120.

It will be appreciated by persons skilled in the art that the above embodiments have been described by way of example only, and not in any limitative sense, and that various alterations and modifications are possible without departure from the scope of the invention which is defined by the appended claims. For example, directional indication could be provided on a numeric keypad by forming each key with an arrow pointing in the direction that it indicates. In other words, the key 38 labelled 3 in FIGS. 3 and 4 could be formed with a small arrow portion extending from the top right-hand corner of the key. As a further alternative the keys that are caused to vibrate to indicate direction could be formed with arrows in their upper surfaces which can be felt by the operator to determine the direction. In a further alternative, the direction of vibration could be indicated by using a pair of keys can be caused to vibrate in a sequence to indicate a direction. For example, a first key vibrates then stops vibrating a second key vibrates then stops vibrating there is then a pause the first key vibrates again, stops the second key vibrates stops then there is a pause. This sequence repeats and indicates a direction from the first key through the second key. Other similar coding could alternatively be used.

In a further alternative, the apparatus can be formed with a single motor, as opposed to the two motors previously described, the output of the single motor being directed to a switching mechanism, such a clutch, which allows one of two shafts having differently eccentrically mounted weights thereon, to be selected and rotated. As a further example of indicating direction, a hand rail could be provided with a series of vibrating devices located within it which are caused to vibrate in sequence causing a pulse to travel along the hand rail. This pulse can therefore indicate a direction and can be used to assist visually impaired people when approaching an escalator or guide them around a building. This technique could be incorporated with RFID tags used to identify a person and cause the hand rail in their vicinity to vibrate thereby guiding them. In the case of an emergency evacuation all handrails could vibrate in the direction of the nearest exit.

It should also be noted that, although the devices and methods described above are primarily for use in assisting people with visual and/or hearing impairments, these devices are also useful where a temporary visual and/or hearing impairment affects a person who does not normally have such an impairment. For example, where poor light, smoke or direct sunlight make a screen difficult to read or where loud noise makes audio cues inaudible.

1-18. (canceled)

19. An apparatus for providing information to an operator of a device, the apparatus comprising:
at least one surface adapted to be touched by an operator, portions of said surface being adapted to vibrate in response to an input signal, the surface having direction indicator means for indicating, by means of vibration, a direction relative to said surface portion; and
at least one vibrator device adapted to cause said portions to vibrate.

20. An apparatus according to claim 19, wherein said direction indicator means comprises at least one reference location whose location relative to said vibrating portion indicates a direction to said operator.

21. An apparatus according to claim 19, wherein said vibrator devices are adapted to vary at least one of the intensity and duration of the vibration of the portion of the surface to provide additional information to said operator.

22. An apparatus according to claim 19, wherein at least one vibrator device comprises at least one motor having a respective eccentric weight mounted on a rotating shaft of said motor.

23. An apparatus according to claim 22, wherein at least one vibrator device comprises a plurality of said motors at least two said motors having different eccentric weights mounted thereon.

24. An apparatus according to claim 19, wherein at least one surface portion comprises a button.

25. An apparatus for dispensing currency, the apparatus comprising:
a device for holding, counting and passing to an operator amounts of currency; and
an apparatus according to any one of the preceding claims for providing information to said operator.

26. A method of providing information to an operator of an apparatus, comprising causing at least one portion of a surface, that is adapted to be touched by an operator, to vibrate in response to an input signal, said surface having at least one direction indicator, the vibration indicating a direction to said operator.

27. A method according to claim 26, further comprising varying one of the intensity and duration of said vibration to provide additional information.

28. A method of providing information via a vibrating haptic device about a device connected to said haptic device, comprising the steps:
varying at least one of intensity and duration of a vibration signal output by a haptic device, thereby providing information about a device attached to said haptic device.

29. A computer program for controlling a haptic device adapted to vibrate to provide information, the program comprising:
first computer code to vary at least one of intensity and duration of a vibration signal output by a haptic device providing information about a device attached to said haptic device.

30. A haptic device for providing information about a device attached to the haptic device, the haptic device comprising:
at least one vibrating device adapted to varying at least one of intensity and duration of a vibration signal output by a haptic device, thereby providing information about a device attached to said haptic device.
